(19) United States
(12) Patent Application Publication
(10) Pub. No.: US 2026/0042477 A1
(43) Pub. Date: Feb. 12, 2026

(54) VEHICLE STEERING WHEEL COMPRISING A PLURALITY OF DIFFERENT ELECTRICAL DEVICES

(71) Applicant: AUTOLIV DEVELOPMENT AB, Vargarda (DE)

(72) Inventors: Victorien VENDRAND, Poitiers (FR); Leopold GUIOCHON, Chiré-en-Montreuil (FR)

(21) Appl. No.: 18/849,911

(22) PCT Filed: Mar. 3, 2023
(86) PCT No.: PCT/EP2023/055435

§ 371 Date: Apr. 8, 2025

(30) Foreign Application Priority Data
Mar. 28, 2022 (FR) FR2202760

(51) Int. Cl. B62D 1/04; B60R 16/023; B60R 16/027

(52) U.S. Cl. CPC B62D 1/046; B60R 16/0231; B60R 16/027

(57) ABSTRACT

A vehicle steering wheel having at least two different electrical devices a power harness arranged to connect the plurality of different electrical devices to an electrical system on board the vehicle, characterized in that the power harness comprises at least one common electrical conductor connected to the at least two different electrical devices.

### TECHNICAL FIELD OF THE INVENTION

The present disclosure relates generally to a vehicle steering wheel which comprises a plurality of different electrical devices, such as electrical units or modules mounted and/or embedded on the steering wheel.

### STATE OF THE ART

It is known in the prior art of vehicle steering wheels to provide a plurality of different electrical devices, such as electrical units or modules mounted and/or embedded on the steering wheel. On the other hand, all these different electrical devices need to be supplied or connected to the electrical system on board the vehicle. The power harness must be designed to supply all these different electrical devices, located and mounted on the steering wheel at various positions spaced-apart from one another. As a result, the power harness is complex and requires a lot of space to run from an upstream power supply point to all the different electrical devices.

### DISCLOSURE OF THE INVENTION

One aim of the present disclosure is to address the above-mentioned drawbacks of the prior art and in particular, firstly, to offer a vehicle steering wheel comprising several separate and different electrical devices, yet with a compact and simple-to-manufacture power harness for connecting all these separate and different electrical devices.

For this a first aspect of the disclosure relates to a vehicle steering wheel comprising:
at least two different electrical devices,
a power harness arranged to connect the plurality of different electrical devices to an electrical system on board the vehicle, characterized in that the power harness comprises at least one common electrical conductor connected to said at least two different electrical devices. The common electrical conductor allows several different electrical devices to be powered or connected with a single cable, reducing the size and complexity of the power harness.

In one embodiment, the common electrical conductor can be electrically connected directly or indirectly to each of the two different electrical devices. In particular, the two different electrical devices can be linked and/or connected in parallel.

According to one embodiment, the power harness may comprise at least two common electrical conductors connected to said at least two different electrical devices. Common electrical conductors enable several different electrical devices to be powered or connected with two cables instead of four, reducing the size and complexity of the power harness.

According to one embodiment, the power harness may comprise only common electrical conductors connected directly or indirectly to said at least two different electrical devices. In particular, there may be at least one particular section or portion of the electrical power harness that comprises only common electrical conductors. For example, a section or portion of the electrical power harness (adjacent to a main connector from the electrical power harness to the electrical system on board the vehicle) may comprise only common electrical conductors connected directly or indirectly to said at least two different electrical devices. According to one embodiment, the power harness may comprise at least one section or portion comprising only common electrical conductors connected directly or indirectly to said at least two different electrical devices.

In the above embodiment, a section or portion of the electrical power harness with only common electrical conductors can be provided in several configurations as stated below:
only two common electrical power supply conductors (“plus” and “minus”),
two common electrical power supply conductors (“plus” and “minus”) and a serial data bus,
two common electrical power supply conductors (“plus” and “minus”) and two serial data buses,
two common electrical power supply conductors (“plus” and “minus”), at least one of which forms a data bus (e.g. via powerline communication),
a single common electrical power supply conductor (“plus”) and each different electrical device connected to ground (e.g. via the frame of the steering wheel),
and any combination of these configurations.

In one embodiment, the different electrical devices can be located and/or mounted on the steering wheel at different positions spaced apart from one another.

According to one embodiment, the different electrical devices can be independent of each other, that is they can each be mounted on the steering wheel in a position of their own without interacting with the other different electrical devices. In particular, several electric control buttons mounted on the same unit or support module to be attached to the steering wheel can collectively form a single different electrical device, rather than each one being a different electrical device.

According to one embodiment:
the power harness may comprise at least one main connector and at least one branch point,
the main connector can be arranged to connect, preferably directly, to the on-board electrical system or to a power supply point on the steering wheel,
the branch point can be connected, preferably directly, to said at least two different electrical devices,
the common electrical conductor being arranged between the main connector and the branch point.

According to one embodiment:
the power harness may comprise at least one main connector and at least two secondary connectors,
the main connector can be arranged to connect, preferably directly, to the on-board electrical system or to a power supply point on the steering wheel,
each secondary connector can be connected, preferably directly, to one of said at least two different electrical devices.

According to one embodiment, the vehicle steering wheel can comprise a rotary connector, wherein the main connector forms the rotary connector, or wherein the main connector is arranged to connect directly to the rotary connector.

According to one embodiment, the vehicle steering wheel may comprise an electronic control unit, for example one common to said at least two different electrical devices, wherein the common electrical conductor is directly connected to the electronic control unit. In this embodiment, the electronic control unit is itself linked or connected to the on-board electrical system, and the power harness is connected upstream to the electronic control unit.

According to one embodiment, the common electrical conductor can be arranged to be connected to a vehicle ground or to a vehicle power source. In other words, the common conductor can be designed to form part of a power supply circuit for the different electrical devices to which it is connected. Provision must therefore be made to support the supplying of electrical operating power, which may be significant, for example, in the case of steering wheel heaters.

According to one embodiment, the common electrical conductor can form a communication bus, arranged to form, for example, a data bus for a controller network (CAN bus “Controller Area Network”), or a local interconnected network (LIN bus “local interconnected network”) or a powerline communication (PLC) computer bus, or a computer bus of a communication system of the Clock Extension Peripheral Interface (CXPI) type according to ISO 20794-3:2020.

According to one embodiment, the common electrical conductor can be provided:
to form part of a supply circuit for the different electrical devices to which it is connected, and
to form a communication bus for exchanging data. It may be possible to combine the power supply function with the communication function, for example with a common power supply conductor forming a powerline communication (PLC) computer bus. The power supply can be direct-current.

In one embodiment, the power harness may comprise at least one common electrical conductor designed to provide multidirectional data exchange and power supply to the different electrical devices to which it is connected. Such an implementation simplifies the architecture of the wiring harness.

In one embodiment, the power harness may comprise two common electrical conductors.

In one embodiment, the power harness may be designed to supply power at a voltage greater than or equal to 12V. The different electrical devices can typically be steering wheel heaters. In particular, the common electrical conductor can be designed to supply power at a voltage greater than or equal to 12V. In particular, the common electrical conductor can be designed to supply power greater than or equal to 20 W, greater than or equal to 30 W, and greater than or equal to 40 W.

According to one embodiment, the vehicle steering wheel may comprise a frame and a material overmolded onto the frame, wherein at least a portion of the power harness including part of the electrical conductor is embedded in the overmolded material. In other words, at least one active part of the power harness (a part comprising electrical cables) is overmolded in the steering wheel. For example, part of the wiring harness could be molded into the rim or one of the steering wheel spokes. The overmolded material can be plastic or polymeric, foamed or unfoamed. For example, polyurethane can be used.

In one embodiment, the vehicle steering wheel can comprise at least three different electrical devices connected to the common electrical conductor.

In one embodiment, the power harness may comprise a plurality of electrical conductors in addition to the common electrical conductor.

According to one embodiment:
a first electrical device of said at least two different electrical devices can be arranged in a first angular sector of the steering wheel,
a second electrical device of said at least two different electrical devices can be arranged in a second angular sector of the steering wheel, distinct from the first angular sector.

In one embodiment, each different electrical device can be connected to the power harness by at least two wires or conductive elements.

In one embodiment, each different electrical device is an independent module.

A second aspect of the disclosure relates to a motor vehicle comprising a vehicle steering wheel according to the first aspect.

### DESCRIPTION OF THE FIGURES

Other features and advantages of the present invention will become more apparent upon reading the following detailed description of an embodiment of the invention, which is provided by way of example but in no manner limited thereto, and illustrated by the attached drawings, wherein:

FIG. 1 shows a simplified view of a vehicle steering wheel comprising several different electrical devices;

FIG. 2 shows a simplified view of the steering wheel shown in FIG. 1: After assembling and connecting the different electrical devices with a power harness, but without any overmolded material around a steering-wheel frame, and without any decorative parts;

FIG. 3 shows a simplified view of the power harness of FIG. 2;

FIG. 4 shows a simplified diagram of a first alternative of a power harness that may equip the vehicle steering wheel of FIG. 1;

FIG. 5 shows a simplified diagram of a second alternative of a power harness that may equip the vehicle steering wheel of FIG. 1;

FIG. 6 shows a simplified diagram of a third alternative of a power harness that may equip the vehicle steering wheel of FIG. 1.

### DETAILED DESCRIPTION OF EMBODIMENT(S)

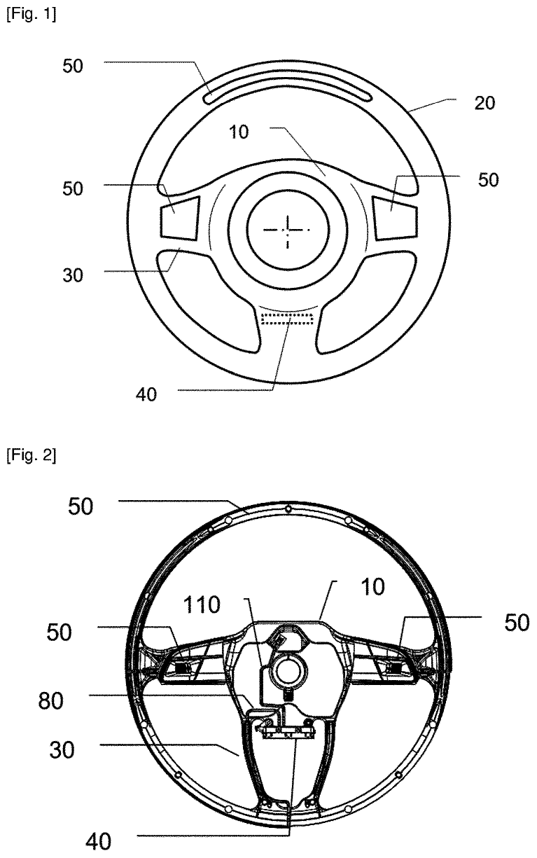

FIG. 1 shows a vehicle steering wheel that generally comprises a hub 10, with a rim 20 connected to the hub by spokes 30. The steering wheel is equipped with an electronic control unit 40, and several different electrical devices 50.

For example, on the left-hand spoke 30, a first different electrical device 50 can be provided to control a car radio. This may be a unit or module that comprises buttons, and/or knobs, and/or light sources and is attached to the left-hand spoke 30. For example, a second, different electrical device 50 in the form of a display bar or light bar can be provided on the upper part of the rim 20 to send information to the driver. For example, on the right-hand spoke 30, a third different electrical device 50 can be provided to control a navigation device (GPS) or a speed control device. This may be a unit or module that comprises buttons, and/or knobs, and/or light sources and is attached to the right-hand spoke 30. The left-hand unit or module 50 is distinct from the right-hand unit 50 because the modules are different and require different power supplies and/or connections, even though they can be functionally linked to the same feature in the vehicle.

Generally speaking, each different electrical device 50 can be fastened to the dedicated steering wheel, to the armature (metal frame of the steering wheel), and/or to a lining material (a polymer overmolding), and/or to decorative or trim parts. In addition, each different electrical device 50 can be fastened by clipping, screwing, resilient interlocking, gluing, riveting, bolting, etc.

All these different electrical devices 50 must be connected to the vehicle's on-board power supply. For this purpose, a power harness 80 can be provided, as shown in FIG. 2, which represents the vehicle steering wheel of FIG. 1 after assembly and connection of the different electrical devices 50, but without the overmolded material around the frame and/or without the decorative parts.

FIG. 2 shows the spokes 30 formed by a metal frame, with the electronic control unit 40 fixed to the hub 10 in the lower position, i.e. “at 6 o'clock”, and connected to the different electrical devices 50 by a power harness 80 running along the rim 20. In the example shown, the electronic control unit 40 is itself also connected to a steering wheel rotary joint via a main harness 110 for connection to the electrical system on board the vehicle.

In other words, in the present example, the electrical supply or connection takes place according to the following sequence: electrical system on board the vehicle, then rotary joint, then electronic control unit 40 via main harness 110, and finally different electrical devices 50 via power harness 80. Of course, other configurations can be envisaged, such as connecting the power harness 80 directly to the rotary joint, or even directly to the on-board electrical system (in this case, the power harness 80 comprises the rotary joint).

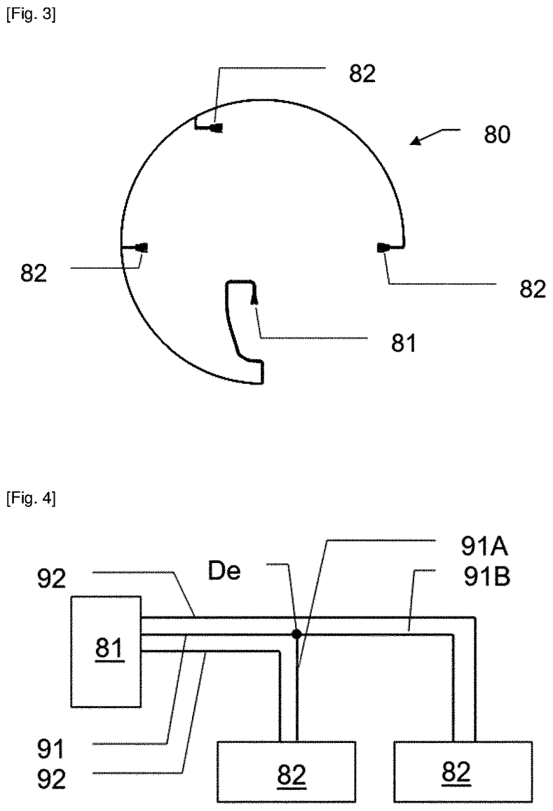

FIG. 3 shows the power harness 80 on its own to illustrate its layout. A main connector 81 enables connection to the electronic control unit 40, and secondary connectors 82 enable connection to each of the different electrical devices 50. The power harness 80 runs from the main connector 80 along the lower spoke 30 and then along the rim 20. However, other configurations are possible, such as starting from one of the spokes 30 on the right or left.

FIG. 4 shows a simplified diagram of a first alternative of a power harness 80 that may equip the vehicle steering wheel of FIG. 1. In this first variant, three cables or three electrical conductors run from the main connector 81 to connect two secondary connectors 82. Two specific electrical conductors 92 each link or connect one of the secondary connectors 82. However, a common electrical conductor 91 runs from the main connector 81 to a branch point De. Next:
a first secondary electrical conductor 91A leads to a first secondary connector 82 (and thus makes the connection with a first different electrical device 50), and
a second secondary electrical conductor 91B leads to a second secondary connector 82 (and thus makes the connection with a second different electrical device 50).

As a result, the common electrical conductor 91 is connected to two different electrical devices 50, either directly or indirectly. This is because the common electrical conductor 91 can simply be extended after the branch point De to form one of the first secondary electrical conductor 91A or the second secondary electrical conductor 91B.

In this first variant, the two specific electrical conductors 92 can form a power supply (+pole and-pole or ground), and the common electrical conductor 91 can form a data bus. Other configurations (typically the ground to the common electrical conductor 91) and additional electrical conductors or cables are of course also possible.

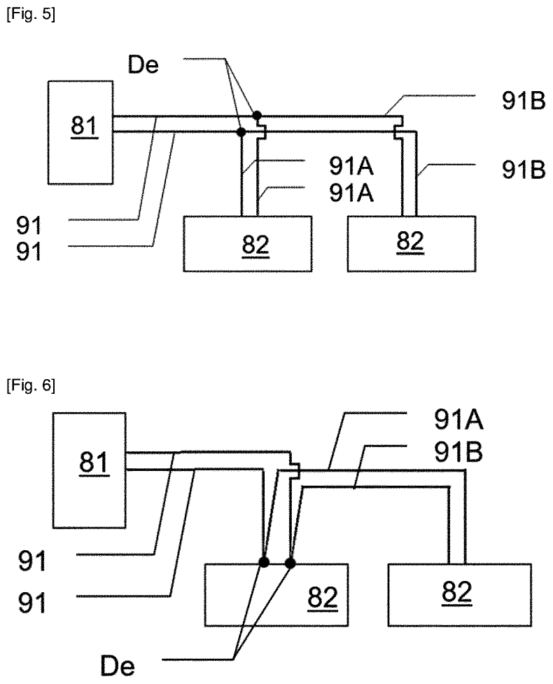

FIG. 5 shows a simplified diagram of a second alternative of the power harness shown in FIG. 3. In this second variant, two common electrical conductors 91 start from the main connector 81 and each run to a branch point De. Then, from each branch point De:
two first secondary electrical conductors 91A run to a first secondary connector 82 (and thus make the connection with a first different electrical device 50), and
two second secondary electrical conductors 91B run to a second secondary connector 82 (and thus make the connection with a second different electrical device 50).

As a result, the common electrical conductors 91 are connected to two different electrical devices 50, either directly or indirectly. This is because each common electrical conductor 91 in FIG. 5 can simply be extended beyond its branch point De to form one or other of the first secondary electrical conductors 91A or one or other of the second secondary electrical conductors 91B.

In this second variant, the two common electrical conductors 91 can provide a power supply (+ pole and − pole or ground), and/or one or more data buses (via powerline communication, for example). Other configurations and additional electrical conductors or cables are of course also possible.

FIG. 6 shows a simplified diagram of a third alternative of the power harness shown in FIG. 3. Indeed, in this third variant, two common electrical conductors 91 run from the main connector 81 to two branch points De directly integrated into a secondary connector 82 (and thus make the connection with a first different electrical device 50). Then, from each branch point De or from the secondary connector 82 in question:
a first secondary electrical conductor 91A runs to a second secondary connector 82 (and thus makes the connection with a second different electrical device 50), and
a second secondary electrical conductor 91B runs to the second secondary connector 82 (and thus makes the connection with the second different electrical device 50).

As a result, the common electrical conductors 91 are connected to two different electrical devices 50, either directly or indirectly. This is because each common electrical conductor 91 in FIG. 6 can simply be extended after its branch point De to form one of the first secondary electrical conductor 91A or the second secondary electrical conductor 91B. This alternative simplifies the creation of branch points De.

In this third variant, the two common electrical conductors 91 can provide a power supply (+ pole and − pole or ground), and/or one or more data buses (via powerline communication, for example). Other configurations and additional electrical conductors or cables are of course also possible.

Summarizing FIGS. 5 and 6, the electrical harness comprises, at least in the portion adjacent to the main connector 81, only common electrical conductors. There could even be just one power supply conductor, if each different electrical device is connected to the steering wheel frame as ground (or has a conductor that isn't part of the wiring harness).

In the spirit of the embodiments shown in FIGS. 5 and 6, there could be, at least in the portion adjacent to the main connector 81:
only two common electrical power supply conductors (“plus” and “minus”),
only two common electrical power supply conductors (“plus” and “minus”) and a serial data bus,
only two common electrical power supply conductors (“plus” and “minus”) and two serial data buses,
only two common electrical power supply conductors (“plus” and “minus”), at least one of which forms a data bus (e.g. via powerline communication),
only one common electrical supply conductor (“plus”) and each different electrical device connected to ground (e.g. via the steering wheel frame), possibly with one or more data buses.

### INDUSTRIAL APPLICATION

A vehicle steering wheel according to the present invention, and its manufacture, are capable of industrial application.

It will be understood that various modifications and/or improvements which are obvious to a person skilled in the art may be made to the different embodiments of the invention described in the present description without departing from the scope of the invention.

In particular, any type of connection can be used to connect the electrical harness 80: reversible connectors, non-detachable connectors, soldered joints, pressure contact joints, etc.

Two, three, four or more different electrical devices can be provided. The same mechanical connector of the power harness can be connected to two different electrical devices (that is, independently mounted on the steering wheel, but close enough to each other to use only one electrical connector).

1-15. (canceled)

16. A vehicle steering wheel comprising:
at least two different electrical devices,
a power harness arranged to connect the plurality of different electrical devices to an electrical system on board the vehicle,
wherein the power harness comprises at least one common electrical conductor connected to said at least two different electrical devices.

17. The vehicle steering wheel according to claim 16, wherein the power harness comprises at least two common electrical conductors (91) connected to said at least two different electrical devices.

18. The vehicle steering wheel according to claim 16, wherein:
the power harness comprises at least one main connector and at least one branch point,
the main connector is arranged to connect, preferably directly, to the on-board electrical system or to a power supply point on the steering wheel,
the branch point is connected, preferably directly, to said at least two different electrical devices,
the common electrical conductor being arranged between the main connector and the branch point.

19. The vehicle steering wheel according to claim 16, wherein:
the power harness comprises at least one main connector and at least two secondary connectors,
the main connector is arranged to connect, preferably directly, to the on-board electrical system or to a power supply point on the steering wheel,
each secondary connector is connected, preferably directly, to one of said at least two different electrical devices.

20. The vehicle steering wheel according to claim 18, comprising a rotary connector, wherein the main connector forms the rotary connector, or wherein the main connector is arranged to connect directly to the rotary connector.

21. The vehicle steering wheel according to claim 18 comprising an electronic control unit, wherein the common electrical conductor is directly connected to the electronic control unit.

22. The vehicle steering wheel according to claim 1, wherein the common electrical conductor is arranged to be connected to a vehicle ground or to a vehicle power source.

23. The vehicle steering wheel according to claim 16, wherein the common electrical conductor forms a communication bus, arranged to form, for example, a data computer bus for a controller network (CAN bus “Controller Area Network”), or a local interconnected network (LIN bus “local interconnected network”) or a powerline communication (PLC) computer bus, or a computer bus of a communication system of the Clock Extension Peripheral Interface (CXPI) type.

24. The vehicle steering wheel according to claim 16, comprising a frame and a material overmolded onto the frame, wherein at least a portion of the power harness including part of the electrical conductor is embedded in the overmolded material.

25. The vehicle steering wheel according to claim 16, comprising at least three different electrical devices connected to the common electrical conductor.

26. The vehicle steering wheel according to claim 16, wherein the power harness comprises a plurality of electrical conductors in addition to the common electrical conductor.

27. The vehicle steering wheel according to claim 16, wherein:
a first electrical device of said at least two different electrical devices is arranged in a first angular sector of the steering wheel,
a second electrical device of said at least two different electrical devices is arranged in a second angular sector of the steering wheel, distinct from the first angular sector.

28. The vehicle steering wheel according to claim 16, wherein each different electrical device is connected to the power harness by at least two wires or conductive elements.

29. The vehicle steering wheel according to claim 16, wherein each different electrical device is an independent module.

30. A motor vehicle comprising a vehicle steering wheel according to claim 16.
